(19) United States
(12) Patent Application Publication
(10) Pub. No.: US 2014/0058584 A1
(43) Pub. Date: Feb. 27, 2014

(54) System And Method For Multimodal Interaction With Reduced Distraction In Operating Vehicles

(71) Applicant: Robert Bosch GmbH, Stuttgart (DE)

(72) Inventors: Fuliang Weng, Mountain View, CA (US); Zhe Feng, Mountain View, CA (US); Zhongnan Shen, Milpitas, CA (US); Kui Xu, Sunnyvale, CA (US)

(73) Assignee: Robert Bosch GmbH, Stuttgart (DE)

(21) Appl. No.: 14/066,423

(22) Filed: Oct. 29, 2013

Related U.S. Application Data
(63) Continuation-in-part of application No. 12/406,661, filed on Mar. 18, 2009.
(60) Provisional application No. 61/720,180, filed on Oct. 30, 2012.

(51) Int. Cl. G06F 7/00

(52) U.S. Cl. CPC G06F 7/00
USPC 701/1

(57) ABSTRACT

A method of interaction with an in-vehicle information system includes receiving first and second inputs from an operator with first and second input devices, respectively. The method further includes identifying a service request corresponding to the first input, and a parameter of the service request with a value that is included in the second input with a controller in the in-vehicle information system. The controller executes stored program instructions to perform the identified service request with reference to the identified parameter.

### CLAIM OF PRIORITY

This patent is a continuation in part of copending U.S. application Ser. No. 12/406,661, which is entitled “System and Method for Multi-Modal Input Synchronization and Disambiguation,” and was filed on Mar. 18, 2009, the contents of which are incorporated by reference in their entirety herein. This patent claims further priority to U.S. Provisional Application No. 61/720,180, which is entitled “System And Method For Multimodal Interaction With Reduced Distraction In Operating Vehicles,” and was filed on Oct. 30, 2012.

### CROSS-REFERENCE

This patent cross-references U.S. Pat. No. 7,716,056, which is entitled “Method and system for interactive conversational dialogue for cognitively overloaded device users,” and was filed on Sep. 27, 2004, the contents of which are expressly incorporated by reference in their entirety herein.

### FIELD

This disclosure relates generally to the field of automated assistance and, more specifically, to systems and methods for recognizing service requests that are submitted with multiple input modes in vehicle information systems.

### BACKGROUND

Spoken language is the most natural and convenient communication tool for people. Advances in speech recognition technology have allowed an increased use of spoken language interfaces with a variety of different machines and computer systems. Interfaces to various systems and services through voice commands offer people convenience and efficiency, but only if the spoken language interface is reliable. This is especially important for applications in eye-busy and hand-busy situations, such as driving a car or performing sophisticated computing tasks. Human machine interfaces that utilize spoken commands and voice recognition are generally based on dialog systems. A dialog system is a computer system that is designed to converse with a human using a coherent structure and text, speech, graphics, or other modalities of communication on both the input and output channel. Dialog systems that employ speech are referred to as spoken dialog systems and generally represent the most natural type of human machine interface. With the ever-greater reliance on electronic devices, spoken dialog systems are increasingly being implemented in many different systems.

In many human-machine interaction (HMI) systems, users can interact with the system through multiple input devices or types of devices, such as through voice input, gesture control, and traditional keyboard/mouse/pen inputs. This provides user flexibility with regard to data input and allows users to provide information to the system more efficiently and in accordance with their own preferences.

Present HMI systems typically limit particular modalities of input to certain types of data, or allow the user to only use one of multiple modalities at one time. For example, a vehicle navigation system may include both a voice recognition system for spoken commands and a touch screen. However, the touch screen is usually limited to allowing the user to select certain menu items by contact, rather than through voice commands. Such multi-modal systems do not coordinate user commands through the different input modalities, nor do they utilize input data for one modality to inform and/or modify data for another modality. Thus, present multi-modal systems do not adequately provide a seamless user interface system in which data from all possible input modalities can be used to provide accurate information to the system.

One common example of an HMI is the interface that a motor vehicle presents to an operator and other occupants in the vehicle. Modern motor vehicles often include one or more in-vehicle information systems that provide a wide variety of information and entertainment options to occupants in the vehicle. Common services that are provided by the in-vehicle information systems include, but are not limited to, vehicle state and diagnostic information, navigation applications, hands-free telephony, radio and music playback, and traffic condition alerts. In-vehicle information systems often include multiple input and output devices. For example, traditional buttons and control knobs that are used to operate radios and audio systems are commonly used in vehicle information systems. More recent forms of vehicle input include touchscreen input devices that combine input and display into a single screen, as well as voice-activated functions where the in-vehicle information system responds to voice commands. Examples of output systems include mechanical instrument gauges, output display panels, such as liquid crystal display (LCD) panels, and audio output devices that produce synthesized speech.

As the functionality and complexity of in-vehicle information systems has increased, the number of potential distractions to the operator of the vehicle has also increased. For example, in-vehicle display screens that display text, graphics, and animations can draw the attention of the operator from the road. Additionally, input devices such as knobs, dials, buttons, and touch-screen interface devices require the operator to remove a hand from contact with a steering wheel during operation of the vehicle. Consequently, improved systems and methods for input and output in a vehicle information system that improve the focus of the operator on the task of operating the vehicle would be beneficial.

### SUMMARY

A multi-modal interaction system for interacting with devices and services in a motor vehicle reduces vehicle operator distraction. The system includes components for gesture recognition and understanding, speech recognition and understanding, feedback and response to drivers, interaction management, and application management. The system enables a vehicle operator to write or draw on a surface in the vehicle, such as the steering wheel or armrest, using hand gestures to input information and/or control instructions. The system also enables voice input through the speech recognition component, and the output is integrated with gesture input and fed into the interaction management system. The interaction management system interprets the input, acts based on the instruction and information in a context and knowledge database, or makes requests for clarifications if the input is insufficient or unclear for the system to act. A feedback module provides the information and/or responses via an audio channel, such as in-car speakers, to provide voice feedback to the input by the user, or via a visual channel such as head up display (HUD), combined head up display (CHUD), or head unit (HU) to display visual feedback to the input by the user. Based on the instructions and information interpreted by the interaction manager, the system invokes the application manager to subsequently operate the devices or access the applications. The multi-modal interaction system reduces operator distraction since the operator remains in contact or in close proximity to the steering wheel for fast response, and the operator maintains eye contact with the road.

In one embodiment, a method of interaction with an in-vehicle information system that reduces operator distraction has been developed. The method includes receiving with a first input device in the in-vehicle information system a first input from an operator, identifying with a controller in the in-vehicle information system a service request corresponding to the first input, identifying with the controller a parameter of the identified service request that is not included in the first input, receiving with a second input device in the in-vehicle information system a second input from the operator, the second input device being different than the first input device, identifying with the controller referencing the second input a value for the parameter of the identified service request that is not included in the first input, and executing with the controller stored program instructions to perform the identified service request with reference to the identified value for the parameter of the service request that is not included in the first input.

In another embodiment, an in-vehicle information system that enables operator input with reduced distraction has been developed. The in-vehicle information system includes a first input device configured to receive input from an operator, a second input device configured to receive input from the operator, and a controller operatively connected to the first input device, the second input device, and a memory. The controller is configured to receive a first input from an operator with the first input device, identify a service request corresponding to the first input, identify a parameter of the identified service request that is not included in the first input, receive a second input from the operator with the second input device, identify a value for the parameter that is not included in the first input with reference to the second input, and execute stored program instruction in the memory to perform the identified service request with reference to the identified value for the identified parameter that is not included in the first input.

### BRIEF DESCRIPTION OF THE DRAWINGS

FIG. 1 illustrates a multi-modal human-machine system, that implements a multi-modal synchronization and disambiguation system, according to an embodiment.

FIG. 2 is a block diagram of a multi-modal user interaction system that accepts a user's gesture and speech as inputs, and that includes a multi-modal synchronization and disambiguation system, according to an embodiment.

FIG. 3 illustrates the processing of input events using a multi-modal user interaction system, under an embodiment.

FIG. 4 is a block diagram of a spoken dialog manager system that implements a multi-modal interaction system, under an embodiment.

FIG. 5 is a flowchart that illustrates a method of processing user inputs in a dialog system through a multi-modal interface, under an embodiment.

FIG. 6 is a schematic view of components of an in-vehicle information system in a passenger compartment of a vehicle.

FIG. 7 is a block diagram of a process for interacting with an in-vehicle information system using multiple input methods.

### DETAILED DESCRIPTION

For the purposes of promoting an understanding of the principles of the embodiments disclosed herein, reference is now being made to the drawings and descriptions in the following written specification. No limitation to the scope of the subject matter is intended by the references. The present disclosure also includes any alterations and modifications to the illustrated embodiments and includes further applications of the principles of the disclosed embodiments as would normally occur to one skilled in the art to which this disclosure pertains.

As used herein, the term “gesture” includes any movement by a human operator that corresponds to an input for control of a computing device, including an in-vehicle parking assistance service. While not a requirement, many gestures are performed with the hands and arms. Examples of gestures include pressing one or more fingers on a surface of a touch sensor, moving one or more fingers across a touch sensor, or moving fingers, hands, or arms in a three-dimensional motion that is captured by one or more cameras or three-dimensional sensors. Other gestures include head movement or eye movements. As used herein, the term “gesture input device” refers to any device that is configured to sense gestures of a human operator and to generate corresponding data that a digital processor or controller interprets as input to control the operation of software programs and hardware components, particularly hardware components in a vehicle. Many gesture input devices include touch-sensitive devices including surface with resistive and capacitive touch sensors. A touchscreen is a video output devices that includes an integrated touch sensor for touch inputs. Other gesture input devices include cameras and other remote sensors that sense the movement of the operator in a three-dimensional space or sense movement of the operator in contact with a surface that is not otherwise equipped with a touch sensor. Embodiments of gesture input devices that are used to record human-machine interactions are described below.

Embodiments of a dialog system that incorporates a multi-modal synchronization and disambiguation system for use in human-machine interaction (HMI) systems are described. Embodiments include a component that receives user inputs from a plurality of different user input mechanisms. The multi-modal synchronization and disambiguation system synchronizes and integrates the information obtained from different modalities, disambiguates the input, and recovers from any errors that might be produced with respect to any of the user inputs. Such a system effectively addresses any ambiguity associated with the user input and corrects for errors in the human-machine interaction.

In the following description, numerous specific details are introduced to provide a thorough understanding of, and enabling description for, embodiments of the multi-modal synchronization and disambiguation system and method. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

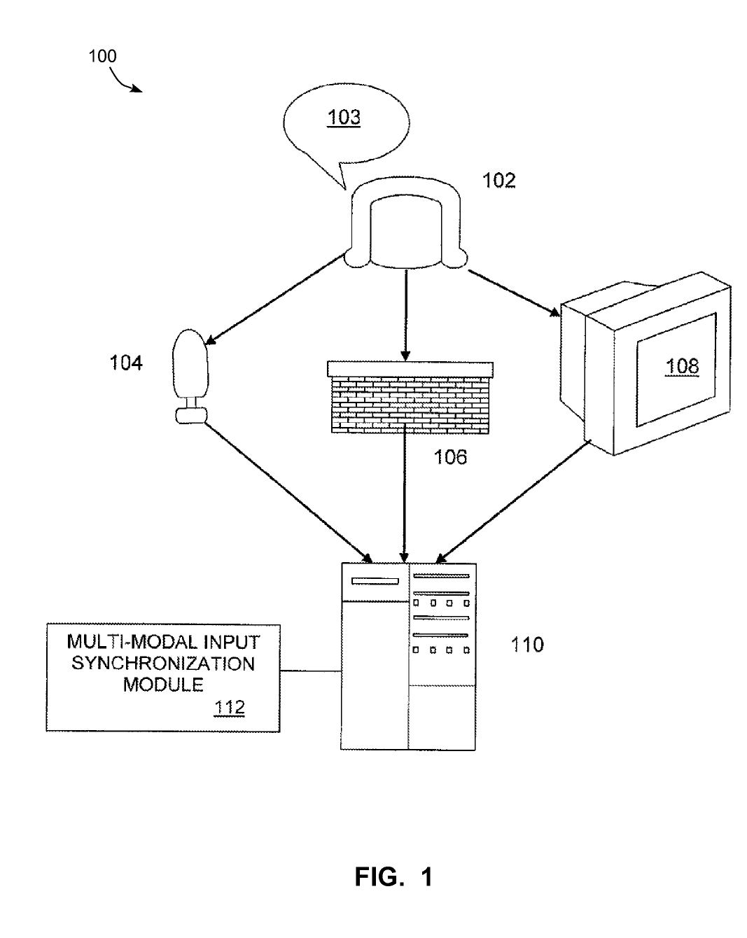

FIG. 1 illustrates a multi-modal human-machine system, that implements a multi-modal synchronization and disambiguation system, according to an embodiment. In system 100, a user 102 interacts with a machine or system 110, which may be a computing system, machine, or any automated electromechanical system. The user can provide input to system 110 through a number of different modalities, typically through voice or touch controls through one or more input means. These include, for example, keyboard or mouse input 106, touch screen or tablet input 108, and/or voice input 103 through microphone 104. Other means of user input are also possible, such as foot controls, keypads, joystick/servo controls, game-pad input, infrared or laser pointers, camera-based gesture input, electromagnetic sensors, and the like. Different user inputs may control different aspects of the machine operation. In certain instances, a specific modality of input may control a specific type of operation. For example, voice commands may be configured to interface with system administration tasks, and keyboard input may be used to perform operational tasks. In one embodiment, the user input from the different input modalities are used to control at least certain overlapping functions of the machine 110. For this embodiment, a multi-modal input synchronization module 112 is used to synchronize and integrate the information obtained from different input modalities 104-108, disambiguate the input, and use input from any modality to correct, modify, or otherwise inform the input from any other modality.

As shown in FIG. 1, in many human-machine interaction (HMI) systems, users can interact with system via multiple input devices, such as touch screen, mouse, keyboard, microphone, and so on. The multi-modal input mechanism provides user flexibility to input information to the system more efficiently any through their preferred method. For example, when using a navigation system, a user may want to find a restaurant in the area. He or she may prefer specifying the region through a touch screen interface directly on a displayed map, rather than by describing it through speech or voice commands. In another example, when a user adds a name of contact into his address book, it may be more efficient and convenient to say the name directly than by typing it through a keyboard or telephone keypad.

Users may also use multiple modalities to achieve their tasks. That is, the machine or an aspect of machine operation may accept two or more modalities of user input. In some cases, a user may utilize all of the possible modalities of input to perform a task. The multi-modal synchronization component 112 allows for the synchronization and integration of the information obtained from different modalities. The different inputs can be used to disambiguate the responses and provide error recovery for any problematic input. In this manner, users can utilize input methods that are most desired, and are not always forced to learn different input conventions, such as new gestures or commands that have unique meanings.

Unlike traditional multi-modal HMI systems that only allow the user to use one of multiple modalities at one time, the multi-modal synchronization component allows the user to input information via multiple modalities at the same time. For example, the user can speak to the system while drawing something on the touch screen. Thus, in a navigation system, the user can utter “find a restaurant in this area” while drawing a circular area on a map display on a touch screen. In this case, the user is specifying what is meant by “this area” through the touch screen input. The determination of the meaning of a user's multi-modal input would depend on the information conveyed in different modalities, the confidence of the modalities at that time, as well as the time of the information received from the different modalities.

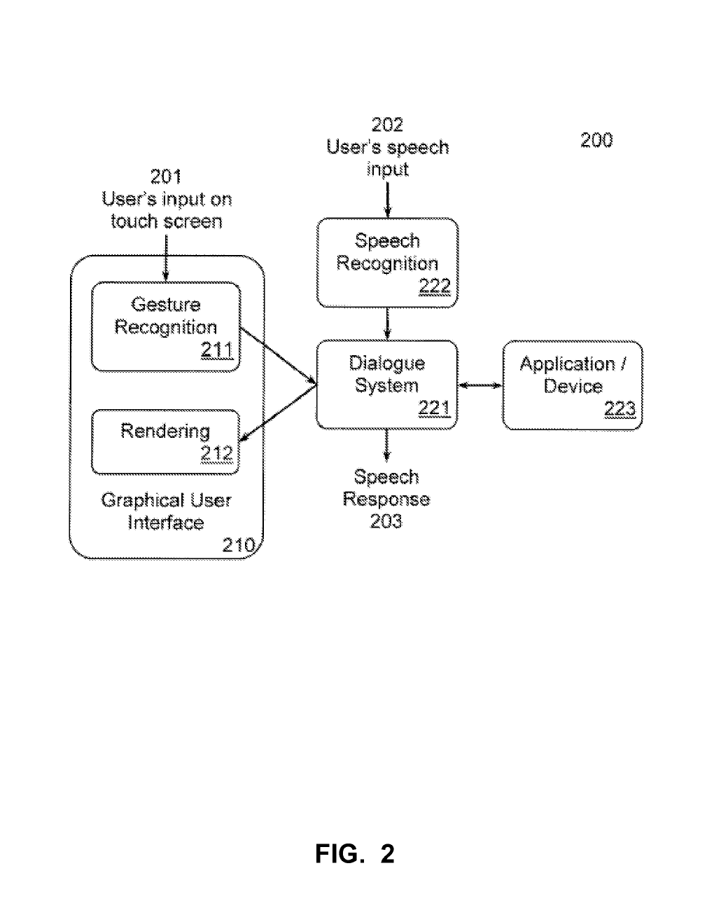

FIG. 2 is a block diagram of a multi-modal user interaction system that accepts user's gesture and speech as input. In a multi-modal user interaction system 200, a user can input information by typing, touching a screen, saying a sentence, or other similar means. Physical gesture input, such as touch screen input 201 is sent to a gesture recognition module 211. The gesture recognition module will process the user's input and classify it into different types of gestures, such as a dragging action, or drawing a point, line, curve, region, and so on. The user's speech input 202 will be sent to a speech recognition module 222. The recognized gesture and speech from the corresponding gesture recognition module and the speech recognition module will be sent to the dialog system 221. The dialog system synchronizes and disambiguates the information obtained from each modality based on the dialog context and the temporal order of the input events. The dialog system interacts with the application or device 223 to finish the task the user specified via multi-modal inputs. The output of the interaction and the results of the executed task are then conveyed to the user through a speech response 203 and/or are displayed through a rendering module 212 on a graphical user interface (GUI) 210. The system 200 of FIG. 2 may be used to perform the input tasks provided in the example above of a user specifying a restaurant to find based on a combination of speech and touch screen input.

A primary function of the multi-modal user interaction system is to distinguish and synchronize user input that may be directed to the same application. Different input modalities may be directed to different tasks, even if they are input at the same time. Similarly, inputs provided by the user at different times through different modalities may actually be directed to the same task. In general, applications and systems only recognize user input that is provided through a proper modality and in the proper time period.

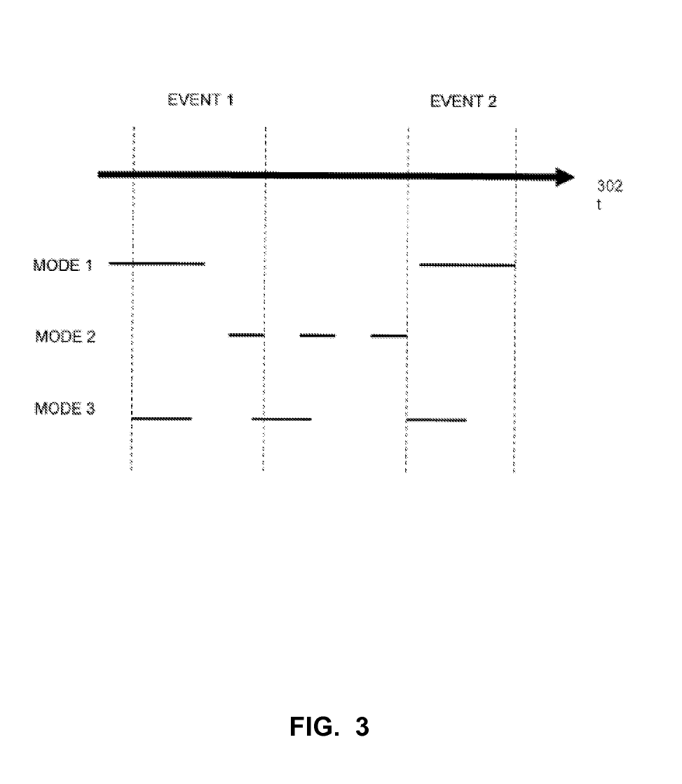

FIG. 3 illustrates the processing of input events using a multi-modal user interaction system, under an embodiment. As shown in FIG. 3, the horizontal axis 302 represents input events for a system along a time axis. Two example events are illustrated as denoted “event 1” and “event 2”. The input events represent valid user input periods for a specific application or task. Three different input modalities denoted modalities 1, 2, and 3, are shown, and can represent a drawing input, a spoken input, a keyboard input, and so on. The different input modalities have user inputs that are valid at different periods of time and for varying durations. For event 1, the user has provided inputs through modalities 1, 2, and 3, but modality 2 is a relatively short and late input. Similarly for event 2, modalities 1 and 3 appear to have valid input, but modality 2 may be early or nonexistent. The multi-modal interaction system may use information provided by any of the modalities to determine whether a particular input is valid, as well as help discern the proper meaning of the input.

The system can also ask for more input from various modalities when the received information is not enough in determining the meaning. The synchronization and integration of multi-modal information can be directed by predefined rules or statistical models developed for different applications and tasks.

The example provided above illustrates the fact that information obtained from a single channel (e.g., voice command) often contains ambiguities. Such ambiguities could occur due to unintended multiple interpretations of the expression by the user. For example, the phrase “this area” by itself is vague unless the user provides a name that is recognized by the system. In another example, a gesture on touch screen may have different meanings. For example, moving a finger along a straight line on a touch screen that shows a map can mean drawing a line on the map or dragging the map in a particular direction. The multi-modal synchronization module makes use of the information from all the utilized modalities to provide the most likely interpretation of the user input. When an ambiguity is detected in the information obtained from a particular channel, different ways can be used at different system states. The system may use prior context to help the disambiguation, or it may ask the user for clarification from the same or different modalities. Continuing with the previous example, assume speech and touch screen are the two input modalities and user moves his or her finger on a map displayed on the touch screen. There are at least two possible interpretations of this gesture: draw a line on the map, or drag the map towards another direction. In this case, if the user says “I want to find some restaurants on this street”, the system would know the user draws the line to specify a street. If the user does not say anything around that time, it is likely that the user just wants to drag the map.

The information obtained from one modality may also contain errors. These errors may come from devices, systems and even users. Furthermore, the error from one modality may also introduce inconsistency with the information from other modalities. The multi-modal synchronization and disambiguation component can resolve the inconsistency, select the correct interpretation, and recover from such errors based on the context and confidence. In one embodiment, the confidence score is calculated by including factors, such as the performance specification of the input device, the importance of a particular modality, the performance of the algorithms used to obtain information from input data, etc. When there are inconsistencies among different modalities, multiple hypotheses together with corresponding confidence scores from each modality are used to decide which ones are the likely ones to be passed to the next stage processing. The aggregated confidence score for each hypothesis is computed through a weighted linear combination of the confidence scores from different available modalities for that hypothesis or through other combination functions.

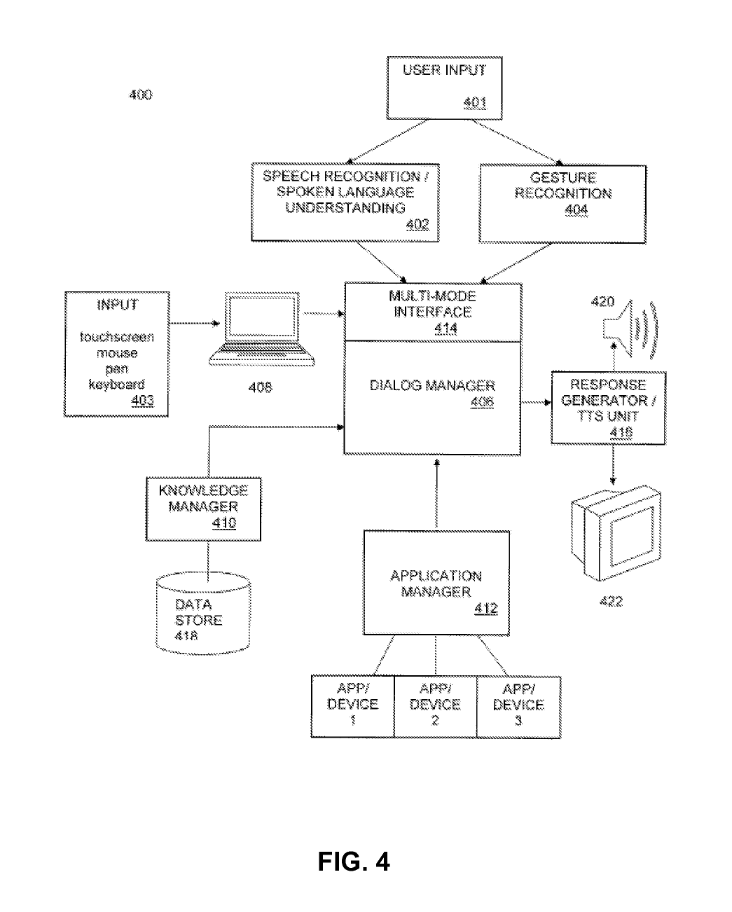

FIG. 4 is a block diagram of a spoken dialog system that implements a multi-modal interaction system, under an embodiment. For purposes of the present description, any of the processes executed on a processing device may also be referred to as modules or components, and may be standalone programs executed locally on a respective device computer, or they can be portions of a distributed client application run on one or more devices. The core components of system 400 include a spoken language understanding (SLU) module and speech recognition (SR) module 402 with multiple understanding strategies for imperfect input, an information-state-update or other kind of dialog manager (DM) 406 that handles multiple dialog threads, a knowledge manager (KM) 410 that controls access to ontology-based domain knowledge, and a data store 418. In one embodiment, user input 401 including spoken words and phrases produces acoustic waves that are received by the speech recognition unit 402. The speech recognition unit 402 can include components to provide functions, such as dynamic grammars and class-based n-grams. The recognized utterance output by speech recognition unit will be processed by spoken language understanding unit to get the semantic meaning of user's voice-based input. In the case where the user input 401 is text-based rather than voice-based, the speech recognition is bypassed and spoken language understanding unit will receive user's text-based input and generate the semantic meaning of user's text-based input. The user input 401 can also include gestures or other physical communication means. In this case, a gesture recognition component 404 converts the recognized gestures into machine recognizable input signals. The gesture input and recognition system could be based on camera-based gesture input, laser sensors, infrared or any other mechanical or electromagnetic sensor based system. The user input can also be provided by a computer or other processor based system 408. The input through the computer 408 can be through any method, such as keyboard/mouse input, touch screen, pen/stylus input, or any other available input means.

For the embodiment of system 400, the user inputs from any of the available methods (voice, gesture, computer, etc.) are provided to a multi-modal interface module 414 that is functionally coupled to the dialog manager 404. The multi-modal interface includes one or more functional modules that perform the task of input synchronization and input disambiguation. The input synchronization function determines which input or inputs correspond to a response for a particular event, as shown in FIG. 3. The input disambiguation function resolves any ambiguity present in one or more of the inputs.

The proper input is then processed by the dialog manager component 404. A response generator and text-to-speech (TTS) unit 416 provides the output of the system 400 and can generate audio, text and/or visual output based on the user input. Audio output, typically provided in the form of speech from the TTS unit, is played through speaker 420. Text and visual/graphic output can be displayed through a display device 422, which may execute a graphical user interface process, such as GUI 210 shown in FIG. 2. The graphical user input may also access or execute certain display programs that facilitate the display of specific information, such as maps to show places of interest, and so on.

The output provided by response generator 416 can be an answer to a query, a request for clarification or further information, reiteration of the user input, or any other appropriate response (e.g., in the form of audio output). The output can also be a line, area or other kind of markups on a map screen (e.g., in the form of graphical output). In one embodiment, the response generator utilizes domain information when generating responses. Thus, different wordings of saying the same thing to the user will often yield very different results. System 400 illustrated in FIG. 4 includes a large data store 418 that stores certain data used by one or more modules of system 400.

System 400 also includes an application manager 412 that provides input to the dialog manager 404 from one or more applications or devices. The application manager interface to the dialog manager can be direct, as shown, or one or more of the application/device inputs may be processed through the multi-modal interface 414 for synchronization and disambiguation along with the user inputs 401 and 403.

The multi-modal interface 414 includes one or more distributed processes within the components of system 400. For example, the synchronization function may be provided in dialog manager 404 and disambiguation processes may be provided in a SR/SLU unit 402 and gesture recognition module 404, and even the application manager 412. The synchronization function synchronizes the input based on the temporal order of the input events as well as the content from the recognizers, such as speech recognizer, gesture recognizer. For example, a recognized speech “find a Chinese restaurant in this area” would prompt the system to wait an input from the gesture recognition component or search for the input in an extended proceeding period. A similar process can be expected for the speech recognizer if a gesture is recognized. In both cases, speech and gesture buffers are needed to store the speech and gesture events for an extended period. The disambiguation function disambiguates the information obtained from each modality based on the dialog context.

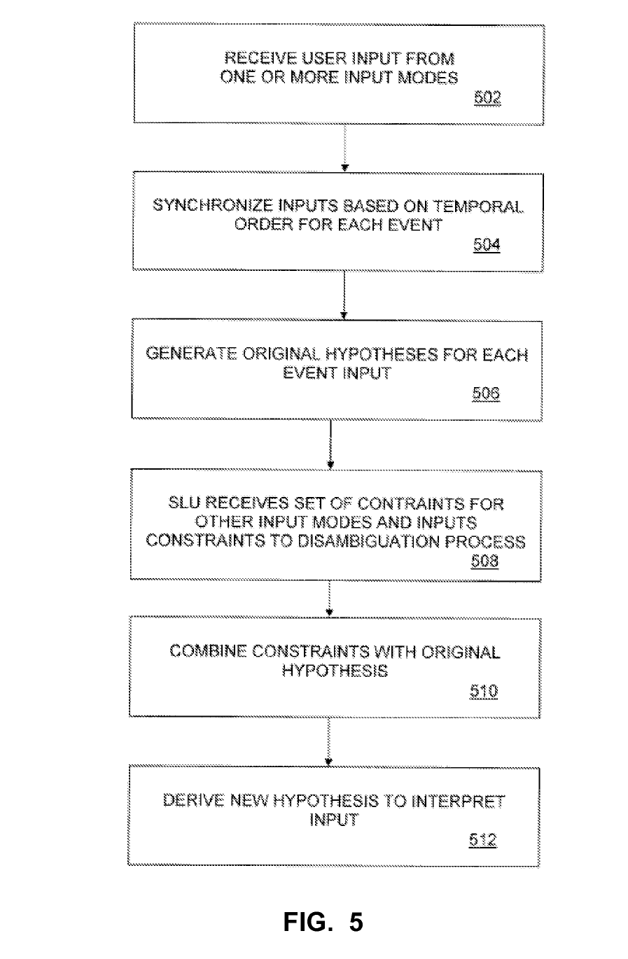

FIG. 5 is a flowchart that illustrates a method of processing user inputs in a dialog system through a multi-modal interface, under an embodiment. Upon receiving an input from the one or more modalities, (block 502). The synchronization functions synchronize the input based on the temporal correspondence of the events to which the inputs may correspond (block 504). For each input, the dialog manager derives an original set of hypothesis regarding the probability of what the input means, block 506. The uncertainty in the hypothesis (H) represents an amount of ambiguity in the input. The probability of correctness for a certain hypotheses may be expressed as a weighted value (W). Thus, each input may have associated with it a hypothesis and weight (H, W). For multiple input modalities, a hypothesis matrix is generated, such as (H1 W1; H2 W2; H3 W3) for three input modalities (e.g., speech/gesture/keyboard).

In certain cases, input from a different input type or modality can help clarify the input from another modality. For example, a random gesture to a map may not clearly indicate where the user is pointing to, but if he or she also says “Palo Alto,” then this spoken input can help remedy ambiguity in the gesture input, and vice-versa. The additional input is received during the disambiguation process in association with the input recognition units. During process 500, the spoken language unit receives a set of constraints from the dialog manager's interpretation of the other modal input, and provides these constraints to the disambiguation process (block 508). The constraints are then combined with the original hypothesis within the dialog manager (block 510). The dialog manager then derives new hypotheses based on the constraints that are based on the other inputs (block 512). In this manner, input from one or more other modalities is used to help determine the meaning of input from a particular input modality.

The multi-modal interface system thus provides a system and method for synchronizing and integrating multi-modal information obtained from multiple input devices, and disambiguating the input based on multi-modal information. This system and method enables a dialog system to detect and recover from errors based on multi-modal information. The system provides more flexibility and convenience to user by allowing user to input information via multiple modalities at the same time. The disambiguation and error recovery mechanisms can improve the performance and robustness of HMI systems. Embodiments of the multi-modal interface system may be used in any type of human-machine interaction (HMI) system, such as dialog systems for operating in-car devices and services; call centers, smart phones or other mobile devices. Such systems may be speech-based systems that include one or more speech recognizer components for spoken input from one or more users, or they may be gesture input, machine entry, or software application input means, or any combination thereof.

Aspects of the multi-modal synchronization and disambiguation process described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: microcontrollers with memory (such as EEPROM), embedded microprocessors, firmware, software, etc. Furthermore, aspects of the content serving method may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

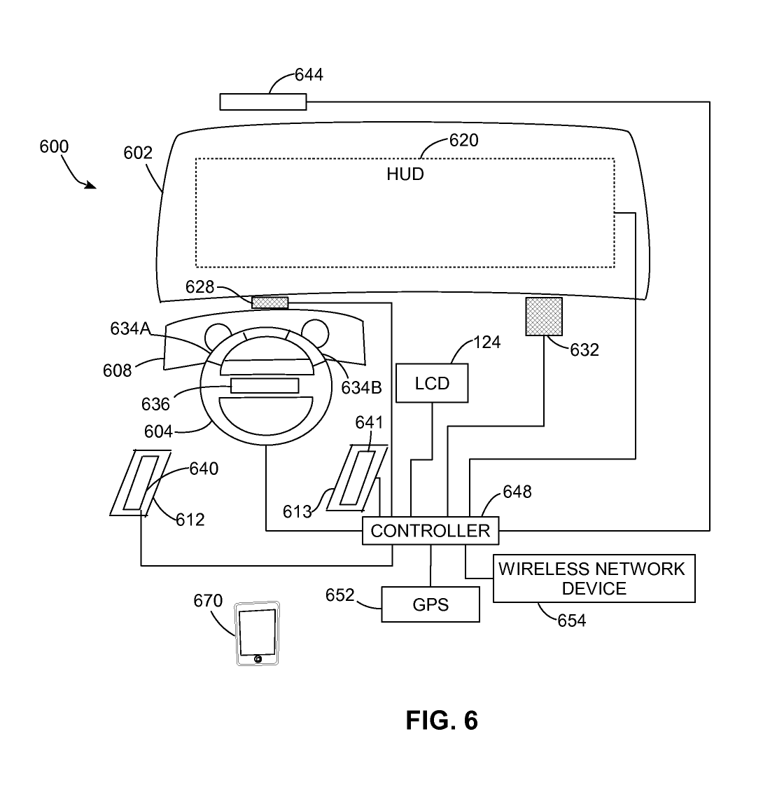

FIG. 6 depicts an in-vehicle information system 600 that is a specific embodiment of a human-machine interaction system found in a motor vehicle. In the environment of a vehicle, the HMI system is configured to enable a human operator in the vehicle to enter requests for services through one or more input modes. The in-vehicle information system 600 implements each input mode using one or more input devices. For example, as describe below, the system 600 includes multiple gesture input devices to receive gestures in a gesture input mode and a speech recognition input device to implement a speech input mode. If necessary, the in-vehicle information system 600 prompts for additional information using one or more input devices to receive one or more parameters that are associated with the service request, and the in-vehicle information system 600 performs requests using input data received from multiple input modalities. The in-vehicle information system 600 provides an HMI system that enables the operator to enter requests for both simple and complex services with reduced distraction to the operator in the vehicle.

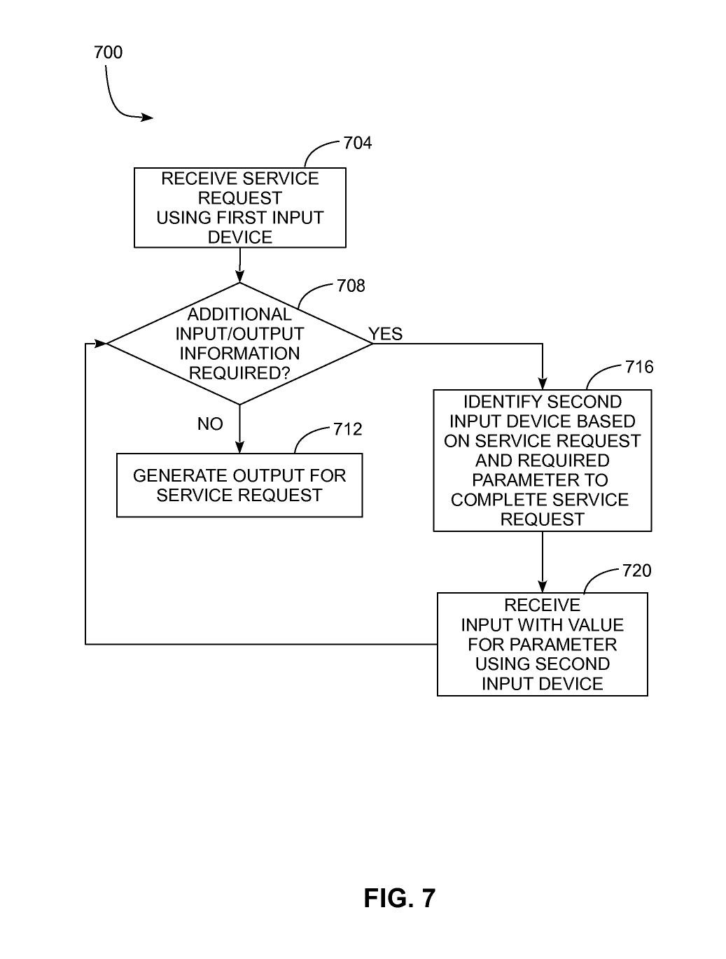

As used herein, the term “service request” refers to a single input or a series of related inputs from an operator in a vehicle that an in-vehicle information system receives and processes to perform a function or action on behalf of the operator. Service requests to an in-vehicle information system include, but are not limited to, requests to operate components in the vehicle such as entertainment systems, power seats, climate control systems, navigation systems, and the like, and requests for access to communication and network services including phone calls, text messages, and social networking communication services. Some service requests include input parameters that are required to fulfill the service request, and the operator uses the input devices to supply the data for some input parameters to the system 600. Additional examples of receiving and processing service requests in an in-vehicle information system are described below in conjunction with FIG. 6 and FIG. 7.

In FIG. 6, the in-vehicle information system 600 includes a head-up display (HUD) 620, one or more console LCD panels 624, one or more input microphones 628, one or more output speakers 632, input regions 634A, 634B, and 636 over a steering wheel area 604, input regions 640 and 641 on nearby armrest areas 612 and 613 for one or both of left and right arms, respectively, and a motion sensing camera 644. The LCD display 624 optionally includes a touchscreen interface to receive touch input. In the system 600, the touchscreen 624 in the LCD display and the motion sensing camera 644 are gesture input devices. While FIG. 6 depicts an embodiment with a motion sensing camera 644 that identifies gestures from the operator, in another embodiment the vehicle includes touch sensors that are incorporated into the steering wheel, arm rests, and other surfaces in the passenger cabin of the vehicle to receive input gestures. The motion sensing camera 644 is further configured to receive input gestures from the operator that include head movements, eye movements, and three-dimensional hand movements that occur when the hand of the operator is not in direct contact with the input regions 634A, 634B, 636, 640 and 641.

In the system 600, a controller 648 is operatively connected to each of the components in the in-vehicle information system 600. The controller 648 includes one or more integrated circuits configured as a central processing unit (CPU), microcontroller, field programmable gate array (FPGA), application specific integrated circuit (ASIC), digital signal processor (DSP), or any other suitable digital logic device. The controller 648 also includes a memory, such as a solid state or magnetic data storage device, that stores programmed instructions for operation of the in-vehicle information system 600. In the embodiment of FIG. 6, the stored instructions implement one or more software applications, input analysis software to interpret input using multiple input devices in the system 600, and software instructions to implement the functionality of the dialog manager 406, knowledge manager 410, and application manager 412, that are describe above with reference to FIG. 4. The memory optionally stores all or a portion of the ontology-based domain knowledge in the data store 418 of FIG. 4, while the system 600 optionally accesses a larger set of domain knowledge through networked services using the wireless network device 654. The memory also stores intermediate state information corresponding to the inputs that the operator provides using the multimodal input devices in the vehicle, including the speech input and gesture input devices. In some embodiments, the controller 648 connects to or incorporates additional components, such as a global positioning system (GPS) receiver 652 and wireless network device 654, to provide navigation and communication with external data networks and computing devices. The in-vehicle information system 600 is integrated with conventional components that are commonly found in motor vehicles including a windshield 602, dashboard 608, and steering wheel 604.

In some operating modes, the in-vehicle information system 600 operates independently, while in other operating modes, the in-vehicle information system 600 interacts with a mobile electronic device, such as a smartphone 670, tablet, notebook computer, or other electronic device. The in-vehicle information system communicates with the smartphone 670 using a wired interface, such as USB, or a wireless interface such as Bluetooth. The in-vehicle information system 600 provides a user interface that enables the operator to control the smartphone 670 or another mobile electronic communication device with reduced distraction. For example, the in-vehicle information system 600 provides a combined voice and gesture based interface to enable the vehicle operator to make phone calls or send text messages with the smartphone 670 without requiring the operator to hold or look at the smartphone 670. In some embodiments, the smartphone 670 includes various devices such as GPS and wireless networking devices that complement or replace the functionality of devices that housed in the vehicle.

In the system 600, the input regions 634A, 634B, 636, and 640 provide a surface for a vehicle operator to enter input data using hand motions or gestures. In one embodiment, the input regions include gesture sensor devices, such as infrared or Time of Fly (TOF) sensors, which identify input gestures from the operator. In another embodiment, the camera 644 is mounted on the roof of the passenger compartment and views one or more of the gesture input regions 634A, 634B, 636, 640, and 641. In addition to gestures that are made while the operator is in contact with a surface in the vehicle, the camera 644 records hand, arm, and head movement in a region around the driver, such as the region above the steering wheel 604.

The camera 644 generates image data corresponding to gestures that are entered when the operator makes a gesture in the input regions, and optionally identifies other gestures that are performed in the field of view of the camera 644. The gestures include both two-dimensional movements, such as hand and finger movements, when the operator touches a surface in the vehicle, or three-dimensional gestures when the operator moves his or her hand above the steering wheel 604. In alternative embodiments, one or more sensors, which include additional cameras, radar and ultrasound transducers, pressure sensors, and magnetic sensors, are used to monitor the movement of the hands, arms, face, and other body parts of the vehicle operator to identify different gestures.

On the steering wheel 604, the gesture input regions 634A and 634B are located on the top of the steering wheel 604, which a vehicle operator may very conveniently access with his or her hands during operation of the vehicle. In some circumstances the operator also contacts the gesture input region 636 to activate, for example, a horn in the vehicle. Additionally, the operator may place an arm on one of the armrests 612 and 613. The controller 648 is configured to ignore inputs received from the gesture input regions except when the vehicle operator is prompted to enter input data using the interface to prevent spurious inputs from these regions.

In some embodiments, the controller 648 is configured to identify written or typed input that is received from one of the interface regions in addition to identifying simple gestures that are performed in three dimensions within the view of the camera 644. For example, the operator engages the regions 636, 640, or 641 with a finger to write characters or numbers. As a complement to the input provided by voice dialog systems, handwritten input is used for spelling an entity name such as a person name, an address with street, city, and state names, or a phone number. An auto-completion feature developed in many other applications can be used to shorten the input. In another embodiment, the controller 648 displays a 2D/3D map on the HUD and the operator may zoom in/out of the map, move the map left, right, up, or down, or rotate the map with multiple fingers. In another embodiment, the controller 648 displays a simplified virtual keyboard using the HUD 620 and the operator selects keys using the—input regions 636, 640, or 641 while maintaining eye contact with the environment around the vehicle through the windshield 602.

The microphone 628 generates audio data from spoken input received from the vehicle operator or another vehicle passenger. The controller 648 includes hardware, such as DSPs, which process the audio data, and software components, such as speech recognition and voice dialog system software, to identify and interpret voice input, and to manage the interaction between the speaker and the in-vehicle information system 600. Additionally, the controller 648 includes hardware and software components that enable generation of synthesized speech output through the speakers 632 to provide aural feedback to the vehicle operator and passengers.

The in-vehicle information system 600 provides visual feedback to the vehicle operator using the LCD panel 624, the HUD 620 that is projected onto the windshield 602, and through gauges, indicator lights, or additional LCD panels that are located in the dashboard 608. When the vehicle is in motion, the controller 648 optionally deactivates the LCD panel 624 or only displays a simplified output through the LCD panel 624 to reduce distraction to the vehicle operator. The controller 648 displays visual feedback using the HUD 620 to enable the operator to view the environment around the vehicle while receiving visual feedback. The controller 648 typically displays simplified data on the HUD 620 in a region corresponding to the peripheral vision of the vehicle operator to ensure that the vehicle operator has an unobstructed view of the road and environment around the vehicle.

As described above, the HUD 620 displays visual information on a portion of the windshield 620. As used herein, the term “HUD” refers generically to a wide range of head-up display devices including, but not limited to, combined head up displays (CHUDs) that include a separate combiner element, and the like. In some embodiments, the HUD 620 displays monochromatic text and graphics, while other HUD embodiments include multi-color displays. While the HUD 620 is depicted as displaying on the windshield 602, in alternative embodiments a head up unit is integrated with glasses, a helmet visor, or a reticle that the operator wears during operation.

During operation, the in-vehicle information system 100 receives input requests from multiple input devices, including, but not limited to, voice input received through the microphone 628, gesture input from the steering wheel position or armrest position, touchscreen LCD 624, or other control inputs such as dials, knobs, buttons, switches, and the like. After an initial input request, the controller 648 generates a secondary feedback prompt to receive additional information from the vehicle operator, and the operator provides the secondary information to the in-vehicle information system using a different input device than was used for the initial input. The controller 648 receives multiple inputs from the operator using the different input devices in the in-vehicle information system 600 and provides feedback to the operator using the different output devices. In some situations, the controller 648 generates multiple feedback prompts to interact with the vehicle operator in an iterative manner to identify specific commands and provide specific services to the operator.

In one example, while driving through a city, the vehicle operator speaks to the in-vehicle information system 600 to enter a question asking for a listing of restaurants in the city. In one operating mode, the HUD 620 displays a map of the city. The operator then makes a gesture that corresponds to a circle on the map displayed on the HUD 620 to indicate the intended location precisely. The controller 648 subsequently generates an audio request for the operator to enter a more specific request asking the operator to narrow the search criteria for restaurants. For example in one configuration, the HUD 620 displays a set of icons corresponding to restaurants meeting the specified requirements. The operator enters a response to the second query with a point gesture or another suitable gesture that is entered though one of the input regions 634A, 634B, 636, 640, and 641. The operator maintains close contact with the steering wheel 604 and maintains eye contact with the environment around the vehicle through the windshield 602 while entering the gesture input. Thus, the in-vehicle information system 600 enables the vehicle operator to interact with the in-vehicle information system 600 using multiple input and output devices while reducing distractions to the vehicle operator. As is known in the art, multiple inputs from different input channels, such as voice, gesture, knob, and button, can be performed in flexible order, and the inputs are synchronized and integrated without imposing strict ordering constraints.

The example described above is an illustrative operation of the in-vehicle information system 100, but the in-vehicle information system 600 is further configured to perform a wide range of additional operations. For example, the in-vehicle information system 600 enables the operator to provide input to select music for playback through the speakers 632, find points of interest and navigate the vehicle to the points of interest, find a person in his/her phone book for placing a phone call, or entry of social media messages without removing his or her eyes from the road through the windshield 602. Using the input regions in the in-vehicle information system 600, the operator enters characters by writing on the input areas and sends the messages without requiring the operator to break eye contact with the windshield 602 or requiring the operator to release the steering wheel 604.

FIG. 7 depicts a process 700 for interacting with an in-vehicle information system, such as the system 100 of FIG. 6. In the description below, a reference to the process 700 performing a function or action refers to a processor, such as one or more processors in the controller 648 or the smartphone 670, executing programmed instructions to operate one or more components to perform the function or action.

Process 700 begins when a service provided by the in-vehicle information system receives a request using an input mode corresponding to a first input device (block 704). In the system 600, the input mode corresponds to an input using any input device that enables the controller 648 to receive the request from the operator. For example, many requests are initiated using a voice input through the microphone 628. To make a request, the vehicle operator utters a key word or key phrase to make the request, such as placing a telephone call, sending a text message to a recipient, viewing a map for navigation, searching for contacts in a social networking service, or any other service that the in-vehicle information system 600 provides. The voice input method enables the vehicle operator to keep both hands in contact with the steering wheel 604. In the system 600, the controller 648 identifies the service request using, for example, the ontology data in the knowledge base. In some instances, the first input includes input from multiple input devices and the controller 648 performs input disambiguation and synchronization to identify the service request using the process 500 of FIG. 5.

In some instances of the process 700, the requested service can be completed through previously entered input data using the first input mode (block 708). In this even, the in-vehicle information system 600 completes the request to perform a service (block 712). For example, if the operator requests a phone call to a recipient whose name is associated with a contact in a stored address book, then the in-vehicle information system 600 activates an internal wireless telephony module or sends a request to perform a phone call to the mobile device 670 to complete the request. For some service requests, the in-vehicle information system 600 generates the output in response to the service request using one or more output devices or other components in the vehicle. For example, a navigation request includes a visual output of a map or other visual navigational guides combined with audio navigation instructions. For some service requests the output is the operation of a component in the vehicle, such as the operation of a climate control system in the vehicle or the activation of motors to adjust seats, mirrors and windows in the vehicle.

During process 700, the controller 648 optionally receives requests for service through a first input device, but the controller 648 requires additional input from the operator to complete the service request (block 708). In the system 600, the controller 648 identifies additional input information that is required from the operator based on the previously received input and identifies a second input mode to receive additional input from the operator using an input device in the vehicle (block 716). The controller 648 identifies required information based on the content of the original service request and a predetermined set of parameters that are required to complete the request using the software and hardware components of the system 600. The system 600 receives values for one or more missing parameters from the operator using one or more of the input devices.

As described above with reference to FIG. 1 and FIG. 4, the system 600 performs disambiguation and error recovery based on the operator input from multiple input devices to identify service requests, identify specific parameters in the service requests, and to identify specific parameters of a request that require additional operator input in order for the system 600 to complete a service request. In the system 600, the controller 648 identifies service requests in the context of a predetermined ontology in the knowledge base for the vehicle information system. The ontology includes structured data that correspond to the service requests that the in-vehicle information system 600 is configured to perform, and the ontology associates parameters with the predetermined service requests to identify information that is required from the operator to complete the service request. In one embodiment, the ontology stores indicators that specify which parameters have values that are received from a human operator using one or more input modes and which parameters are received from sensors and other automated devices that are associated with vehicle. For example, some service requests also include input parameters that the controller 648 retrieves from sensors and devices in the vehicle in an automated manner, such as a geolocation parameter for the location of the vehicle that is retrieved from the GPS 652. The ontology also includes data that are used to provide context to user input in the specific domain of operation for the vehicle. The controller 648 generates prompts for additional information using one or more input devices based on the information for each input parameter stored in the ontology.

In one embodiment, the controller 648 selects an input device that receives the additional input from the operator based on a predetermined data type that is associated with the missing parameter in the service request. For example, if the required input parameter is a short text passage, such as a name, address, or phone number, then the controller 648 selects an audio input mode with an audio input device to receive the information with an option to accept touch input gestures if the audio input mode fails due to noisy ambient conditions. For more complex text input, such as the content of a text message, the controller 648 selects a touch gesture input mode using the touch input devices to record handwritten gestures or touch input to a virtual keyboard interface. If the required input is a geographic region, then the controller 648 generates a map display and prompts for a gesture input to select the region in a larger map using, for example, and input gesture to circle an area of interest in the map.

To complete a service request that requires additional information from the operator, the system 600 receives additional input that includes a value for the missing parameter from the operator through a second input device (block 720). In some instances, the system 600 receives the second input from the user with the second input mode occurring concurrently or within a short time of the first input. For example, to request that the in-vehicle information system 600 display all fueling stations within a predetermined geographic area while viewing a mapping application, the operator initiates a service request with an audible input command to the in-vehicle information system 600 and the operator enters a gesture with a gesture input device to specify a geographic region of interest for locating the fueling stations. The controller 648 receives the two operator inputs using the audio input and gesture input devices in the vehicle, and the control 648 associates the two different inputs with corresponding parameters in the service request to process the service request.

During process 700, the audible and gesture inputs in the example provided above can occur in any order or substantially simultaneously. For example, in one configuration the controller 648 does not directly identify a service request from the gesture input that circles a geographic region on a map display, but the controller 648 retains the gesture input in the memory for a predetermined time that enables the operator to provide the audible input to request the location of fuel stations. The previously received gesture input is a parameter to the request, even though the input for the request is received after the entry of the parameter. Thus, the “first” and “second” inputs that are referred to in process 700 are not restricted to a particular chronological order and the system 600 receives the second input before or concurrently to the first input in some instances.

In some operating modes, the in-vehicle information system 600 generates a prompt to receive the additional information for one or more parameters of the service request from the operator. In one configuration, the second input mode is the same input mode that the operator has used to provide information during the request. In one configuration, the controller 648 generates audio prompts for the operator to state the phone number to call when an operator requests a phone call for a contact that is not listed in the address book. For example, to send a text message, the HUD 620 displays text and prompts the operator for gestures to input letters and numbers. The operator uses the gesture input devices in the system 600 to input text for the text message.

During process 700, the controller 648 associates multiple inputs using the voice or gesture input devices to identify multi-modal inputs that correspond to a single event in a similar manner to the multiple input modalities that are associated with different events in FIG. 3. In the system 600, the controller 648 stores the state of a voice input interaction with the operator in an internal memory. The controller 648 associates an event with the data received from the voice input. For example, if the event is a service request to send a text message, the controller 648 associates the first mode of input with the voice command and a second mode of input with additional input gestures from the operator that specify the input text for the text message using, for example, handwritten input or a virtual keyboard with the input regions 634A, 634B, 636, 640, and 641. Thus, the controller 648 synchronizes operator inputs from multiple input devices in the in-vehicle information system 600 in a similar manner to the multimodal input synchronization module 112 of the system 100.

In one example of interaction with the system 600, the vehicle operator provides input gestures on one of the touch surfaces to spell the letters corresponding to a contact name or to spell words in a text message. The in-vehicle information system 600 provides auto-complete and spelling suggestion services to assist the operator while entering the text. For a navigation application, the HUD 620 displays a map and the operator makes hand gestures to pan the map, zoom in and out, and to highlight regions of interest on the map. In the embodiment of FIG. 6, the camera 644 records a circular hand gesture that the operator performs above the steering wheel 604 to select a corresponding region on a map that is displayed on the HUD 620. The operator maintains contact with the steering wheel 604 using the other hand the system 600 records the gesture without requiring the operator to look away from the road through the windshield 602. In another operation, the operator views the locations of one or more acquaintances on a social networking service on a map display and the in-vehicle information system 600 provides navigation information to reach the acquaintance when the operator points at the location of the acquaintance on the map.

During process 700, the system 600 receives additional input from the operator using one or more operating modes in an iterative manner using the processing that is described with reference to blocks 716 and 720 until the system has received input values for each of the parameters that are required to perform a service request (block 708). The controller 648 performs the service request for the operator once the system 600 has received the appropriate input data using one or more input devices in the in-vehicle information system 600 (block 712).

It will be appreciated that variants of the above-disclosed and other features and functions, or alternatives thereof, may be desirably combined into many other different systems, applications or methods. For example, while the foregoing embodiments present an example of an in-vehicle intelligent assistant system, alternative embodiments of the information system 600 can be integrated with a wide variety of electronic devices, including mobile electronic communication devices and power tools, to reduce operator distraction. Various presently unforeseen or unanticipated alternatives, modifications, variations or improvements may be subsequently made by those skilled in the art that are also intended to be encompassed by the following claims.

What is claimed is:

1. A method of interaction with an in-vehicle information system comprising:
receiving with a first input device in the in-vehicle information system a first input from an operator;
identifying with a controller in the in-vehicle information system a service request corresponding to the first input;
identifying with the controller a parameter of the identified service request that is not included in the first input;
receiving with a second input device in the in-vehicle information system a second input from the operator, the second input device being different than the first input device;
identifying with the controller referencing the second input a value for the parameter of the identified service request that is not included in the first input; and
executing with the controller stored program instructions to perform the identified service request with reference to the identified value for the parameter of the service request that is not included in the first input.

2. The method of claim 1 wherein the first input is received with an audio input device and the second input is received with a gesture input device.

3. The method of claim 1 further comprising:
generating with an output device an output to prompt the operator for the second input corresponding to the identified parameter of the service request that is not included in the first input.

4. The method of claim 1 further comprising:
receiving the second input from the operator prior to receiving the first input from the operator.

5. The method of claim 1 further comprising:
receiving the first input from the operator prior to receiving the second input from the operator.

6. The method of claim 1, the identification of the service request further comprising:
identifying with the controller the service request from a plurality of predetermined service requests in an ontology stored in a memory, the plurality of predetermined service requests being associated with a plurality of predetermined functions of the in-vehicle information system.

7. The method of claim 6, the identification of the parameter that is not included in the first input further comprising:
identifying with the controller the parameter that is not included in the first input with reference to a first parameter associated with the service request in the ontology and an indicator in the ontology specifying that the first parameter corresponds to input from the operator.

8. The method of claim 7 further comprising:
selecting with the controller the second input device from a plurality of input devices with reference to a data type of the first parameter that is not included in the first input.

9. The method of claim 7 further comprising:
identifying with the controller a second parameter associated with the service request in the ontology and another indicator in the ontology specifying that the second parameter corresponds to input from a sensor operatively connected to the in-vehicle information system; and
retrieving with the controller data from the sensor to provide a value for the second parameter to the service request.

10. An in-vehicle information system comprising:
a first input device configured to receive input from an operator;
a second input device configured to receive input from the operator; and
a controller operatively connected to the first input device, the second input device, and a memory, the controller being configured to:
receive a first input from an operator with the first input device;
identify a service request corresponding to the first input;
identify a parameter of the identified service request that is not included in the first input;
receive a second input from the operator with the second input device;
identify a value for the parameter that is not included in the first input with reference to the second input; and
execute stored program instruction in the memory to perform the identified service request with reference to the identified value for the identified parameter that is not included in the first input.

11. The system of claim 10 wherein the first input device further comprises an audio input device and the second input device further comprises a gesture input device.

12. The system of claim 10 further comprising:
an output device; and
the controller being operatively connected to the output device and further configured to:
generate an output to prompt the operator for the second input corresponding to the value of the identified parameter of the service request that is not included in the first input.

13. The system of claim 10 wherein the controller receives the second input from the operator prior to receiving the first input from the operator.

14. The system of claim 10 wherein the controller receives the first input from the operator prior to receiving the second input from the operator.

15. The system of claim 10, the controller being further configured to:
identify the service request from a plurality of predetermined service requests in an ontology stored in the memory, the plurality of predetermined service requests being associated with a plurality of predetermined functions of the in-vehicle information system.

16. The system of claim 15, the controller being further configured to:
identify the parameter not included in the first input with reference to a first parameter associated with the service request in the ontology and an indicator in the ontology specifying that the first parameter corresponds to input from the operator.

17. The system of claim 16, the controller being further configured to:
select the second input device from a plurality of input devices with reference to a data type of the first parameter.

18. The system of claim 16 further comprising:
a sensor; and
the controller being operatively connected to the sensor and configured to:
identify a second parameter associated with the service request in the ontology and corresponding to input from the sensor; and
retrieve data from the sensor to provide the second parameter to the service request.
